(19) United States
(12) Patent Application Publication
(10) Pub. No.: US 2025/0226876 A1
(43) Pub. Date: Jul. 10, 2025

(54) BEAM FAILURE DETECTION REFERENCE SIGNAL POOL CONFIGURATION FOR PER TRANSMISSION RECEPTION POINT BEAM FAILURE RECOVERY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/853,713

(22) PCT Filed: May 16, 2022
(86) PCT No.: PCT/CN2022/092930

§ 371 Date: Oct. 2, 2024

(51) Int. Cl. H04B 7/06; H04W 72/231

(52) U.S. Cl. CPC H04B 7/06964; H04W 72/231

(57) ABSTRACT

A UE receives a radio resource control (RRC) configuration of a first set of reference signals for beam failure detection (BFD) and receives a medium access control-control element (MAC-CE) indicating a second set of reference signals for the BFD. The UE performs the BFD for at least one of multiple transmission reception points (TRPs) using the first set of reference signals or the second set of reference signals based on a condition having been met.

### TECHNICAL FIELD

The present disclosure relates generally to communication systems, and more particularly, to wireless communication including beam failure detection.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives a radio resource control (RRC) configuration of a first set of reference signals for beam failure detection (BFD) and receives a medium access control-control element (MAC-CE) indicating a second set of reference signals for the BFD. The apparatus performs the BFD for at least one of multiple transmission reception points (TRPs) using the first set of reference signals or the second set of reference signals based on a condition having been met.

In an aspect of the disclosure, a method, a computer-readable medium, and an apparatus are provided for wireless communication at a network node. The apparatus outputs for transmission an RRC configuration of a first set of reference signals for BFD; outputs for transmission a MAC-CE indicating a second set of reference signals for the BFD; and receives a BFR request for at least one of multiple TRPs based on the first set of reference signals or the second set of reference signals based on a condition having been met.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating various aspects of beamforming and communication between a UE and a base station based on directional beams, in accordance with various aspects of the present disclosure.

FIG. 5 illustrates aspects of beam failure detection and beam failure recovery between a UE and a base station, in accordance with various aspects of the present disclosure.

FIG. 6A and FIG. 6B illustrate various aspects of RRC configured BFD RSs and MAC-CE activated BFD RSs, in accordance with various aspects of the present disclosure.

FIG. 7 is an example communication flow between a UE and a base station having multiple TRPs, in accordance with various aspects of the present disclosure.

FIG. 8 is an example communication flow between a UE and a base station having multiple TRPs, in accordance with various aspects of the present disclosure.

FIG. 9 is a flowchart of a method of wireless communication at a UE, in accordance with various aspects of the present disclosure.

FIG. 10 is a diagram illustrating an example of a hardware implementation for an example apparatus and/or UE, in accordance with various aspects of the present disclosure.

FIG. 11 is a flowchart of a method of wireless communication at a network node, in accordance with various aspects of the present disclosure.

FIG. 12 is a diagram illustrating an example of a hardware implementation for an example network entity, e.g., network node, in accordance with various aspects of the present disclosure.

### DETAILED DESCRIPTION

A UE may communicate with a base station having more than one TRP. The UE may perform BFD for the multiple TRPS. In some aspects, a UE may be RRC configured with a set of candidate reference signals (RSs) for BFD. The UE may also receive a MAC-CE that activates a subset of the RRC configured BFD RSs. Aspects presented herein provide various mechanisms that enable a UE to determine for one or more TRPs whether to apply the RRC configured BFD RSs or the MAC-CE activated BFD RSs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

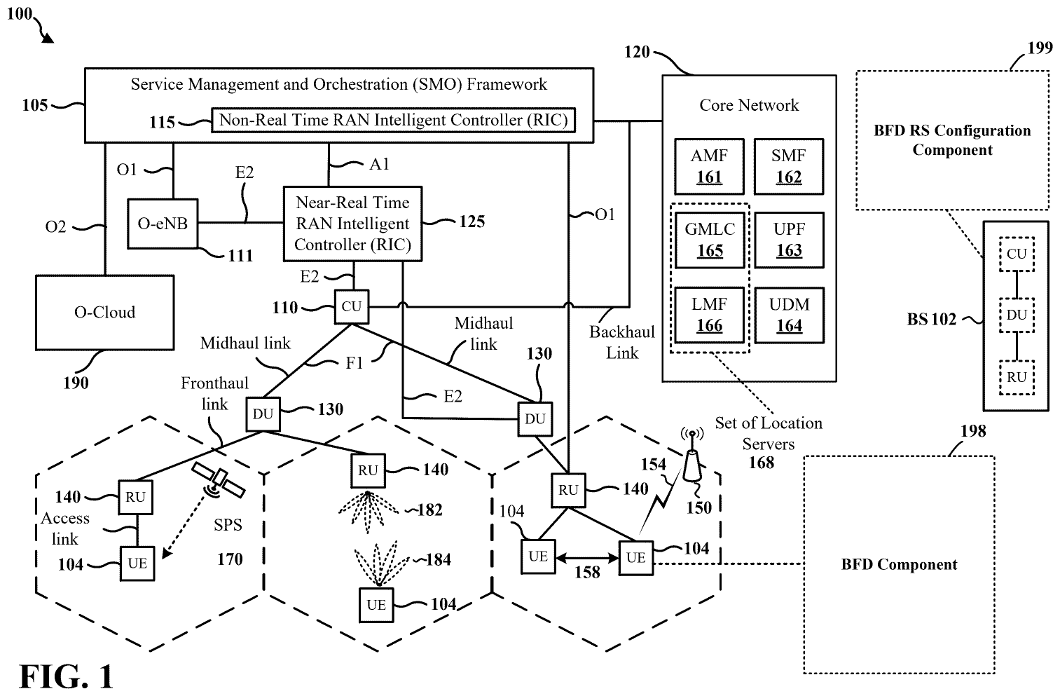

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include BFD component 198 configured to receive an RRC configuration of a first set of reference signals for BFD, receive a MAC-CE indicating a second set of reference signals for the BFD, and perform the BFD for at least one of multiple TRPs using the first set of reference signals or the second set of reference signals based on a condition having been met. In certain aspects, the base station 102 may include a BFD RS configuration component 199 that is configured to output for transmission an RRC configuration of a first set of reference signals for BFD; output for transmission a MAC-CE indicating a second set of reference signals for the BFD; and receive a BFR request for at least one of multiple TRPs based on the first set of reference signals or the second set of reference signals based on a condition having been met. Although the following description may be focused on 5G NR, the concepts described herein may be applicable to other similar areas, such as LTE, LTE-A, CDMA, GSM, and other wireless technologies.

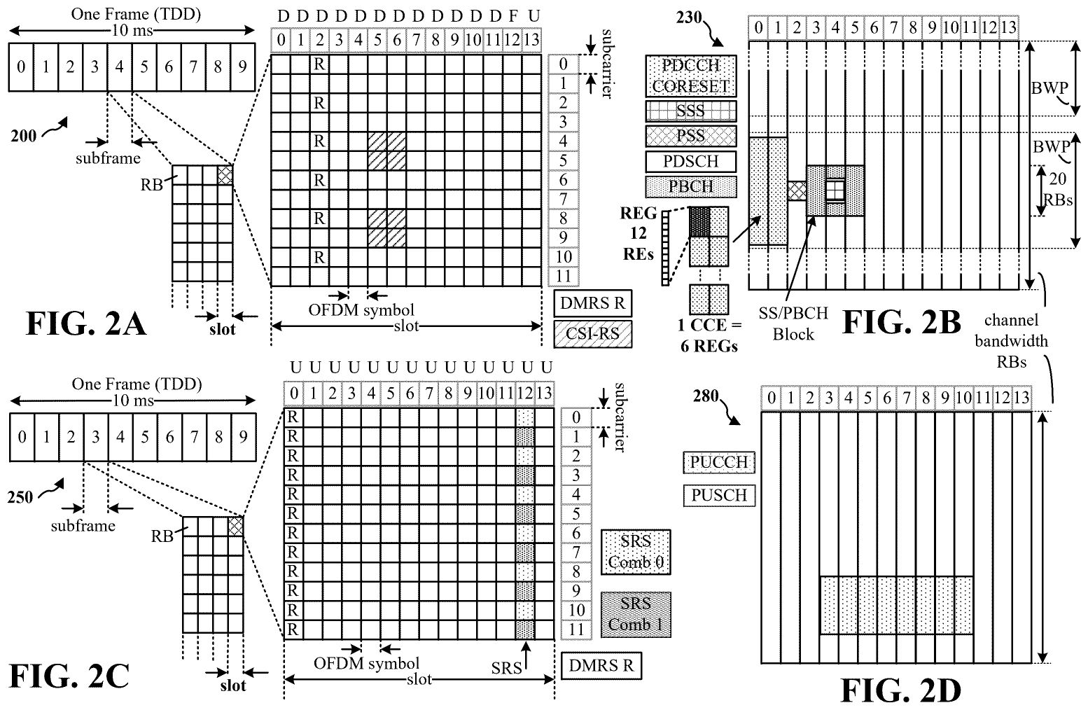

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

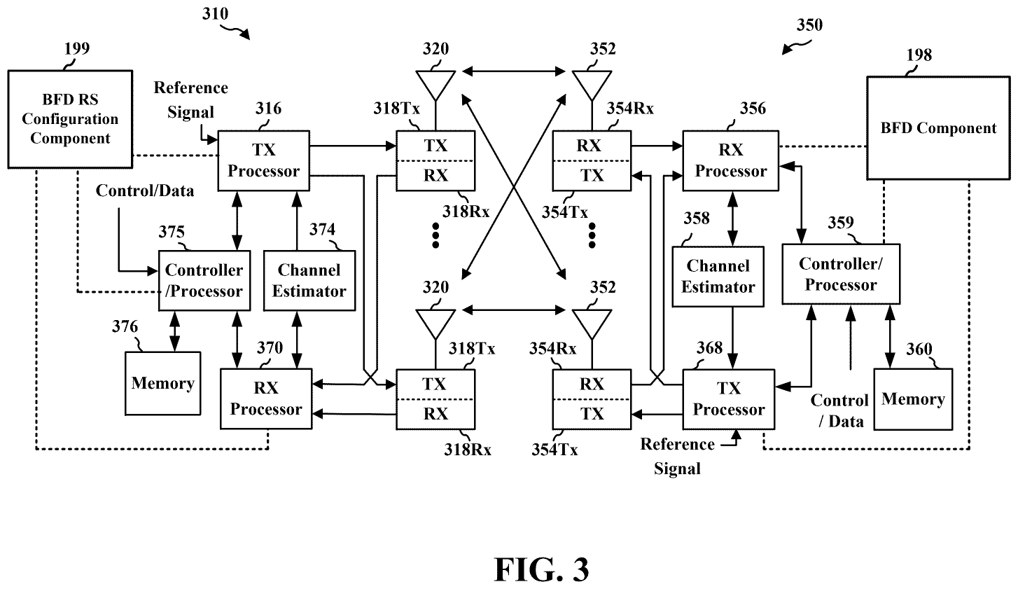

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the BFD component 198 of FIG. 1.

At least one of the TX processor 316, the RX processor 370, and the controller/processor 375 may be configured to perform aspects in connection with the BFD RS configuration component 199 of FIG. 1.

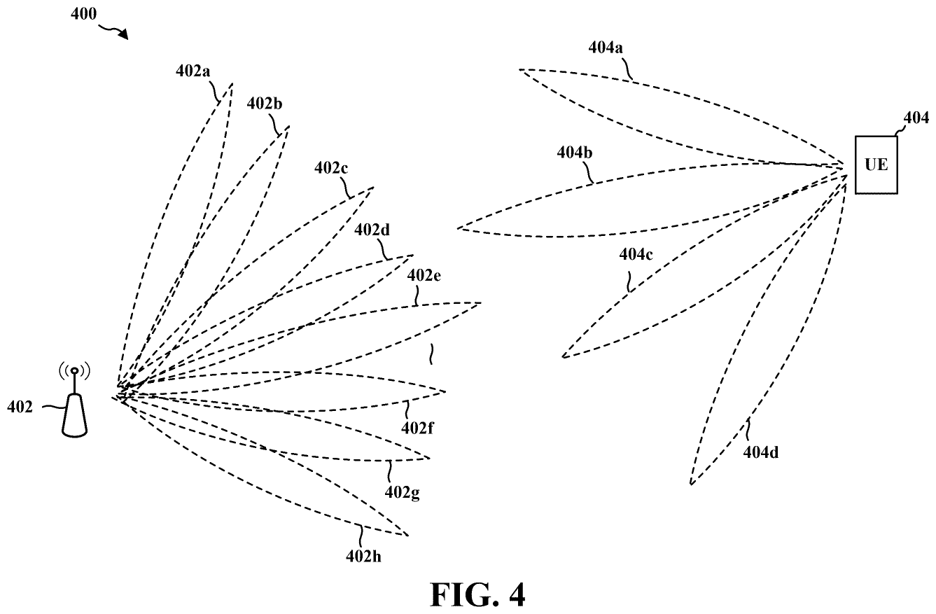

As illustrated in the diagram 400 in FIG. 4, the base station 402 and UE 404 may use beamformed communication to communicate over active data/control beams, e.g., directional beams, both for downlink communication and uplink communication. The base station and/or UE may perform beam management to perform measurements for various beams and to switch to an improved beam as conditions change. In some aspects, the UE and/or base station may switch to using a new beam direction based on beam failure recovery procedures. Referring to FIG. 4, the base station 402 may transmit a beamformed signal to the UE 404 in one or more of the directions 402a, 402b, 402c, 402d, 402e, 402f, 402g, 402h. The UE 404 may receive the beamformed signal from the base station 402 in one or more receive directions 404a, 404b, 404c, 404d. The UE 404 may also transmit a beamformed signal to the base station 402 in one or more of the directions 404a-404d. The base station 402 may receive the beamformed signal from the UE 404 in one or more of the receive directions 402a-402h. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same.

In response to different conditions, the UE 404 may determine to switch beams, e.g., between beams 402a-402h. The beam at the UE 404 may be used for reception of downlink communication and/or transmission of uplink communication. In some examples, the base station 402 may send a transmission that triggers a beam switch by the UE 404. For example, the base station 402 may indicate a transmission configuration indication (TCI) state change, and in response, the UE 404 may switch to a new beam for the new TCI state of the base station 402. In some instances, a UE may receive a signal, from a base station, configured to trigger a transmission configuration indication (TCI) state change via, for example, a MAC control element (CE) command. The TCI state change may cause the UE to switch to a corresponding beam. Switching beams may provide an improved connection between the UE and the base station by ensuring that the transmitter and receiver use the same configured set of beams for communication.

A TCI state may include quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

A UE may need to monitor the quality of the beams that it uses for communication with a base station. For example, a UE may monitor a quality of a signal received via reception beam(s). A Beam Failure Detection (BFD) procedure may be used to identify problems in beam quality and a Beam recovery procedure (BFR) may be triggered when a beam failure is detected. The BFD procedure may indicate whether a link for a particular beam is in failure or not, which may be referred to as a beam failure instance. For monitoring active link performances, a UE may perform measurements of at least one signal, e.g., reference signals, for beam failure detection. The measurements may include deriving a metric similar to a Signal to Interference plus Noise Ratio (SINR) for the signal, or RSRP strength or block error rate (BLER) of a reference control channel chosen by base station and/or implicitly derived by UE based on the existing RRC configuration. The reference signal may comprise any of CSI-RS, Physical Broadcast Channel (PBCH), a synchronization signal, or other reference signals for time and/or frequency tracking, etc. The UE may receive an indication of reference signal resources to be used to measure beam quality in connection with BFD. The UE may monitor the reference signal(s) and determine the signal quality, e.g., Reference Signal Received Power (RSRP) for the reference signal. In some cases, the UE may determine a configured metric such as block error rate (BLER) for a reference signal. The measurement(s) may indicate the UE's ability to decode a transmission, e.g., a DL control transmission from the base station.

Thresholds may be defined in tracking the radio link conditions, the threshold(s) may correspond to an RSRP, a BLER, etc. that indicates an “beam failure” condition, e.g., a beam failure instance, of the radio link. An “beam failure” condition may indicate that the beam of radio link condition is poor. A beam failure condition may be declared when a block error rate for the radio link falls below a threshold over a specified time interval, e.g., a 200 ms time interval. If the UE receives a threshold number of consecutive measurements indicating radio falls below a threshold, which may be referred to as beam failure instances (BFIs) over a period of time, the UE may identify a beam failure detection (BFD) and may declare a beam failure to the network.

When a beam failure is detected, a UE may take appropriate actions to recover the connection. For example, after multiple measurements to beam failure detection resources, the UE may transmit a beam failure recovery signal to initiate recovery of the connection with the base station. For example, the UE may be configured by RRC with a beam failure recovery procedure that is used to indicate to the base station that the beam failure has been detected.

As described in connection with FIG. 4, the base station 402 and UE 404 may communicate over active data/control beams both for DL communication and UL communication. The base station and/or UE may switch to a new beam direction using beam failure recovery procedures.

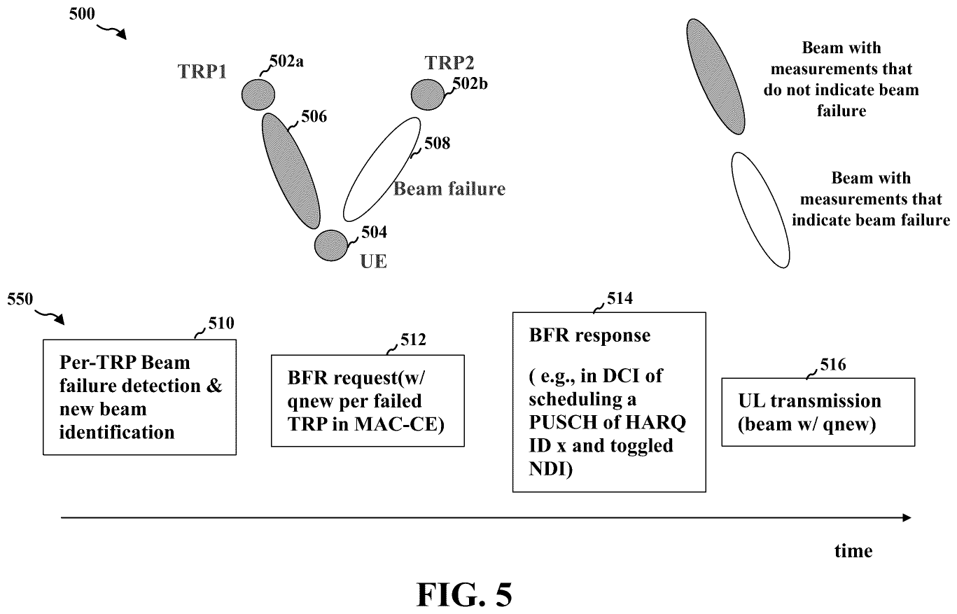

In some aspects, the UE 404 may communicate with the network, e.g., the base station 402 using multiple TRPs. FIG. 5 includes an example diagram 500 showing a UE 504 that communicates with a base station, serving cell, network node, etc. using at least first TRP 502a and a second TRP 502b. FIG. 5 also includes a timeline 550 that illustrates a BFR procedure for one of the multiple TRPs. As illustrated at 510, the UE performs beam failure detection, e.g., BFD, per TRP. For example, the UE measures one or more reference signals from the first TRP 502a to may determinations about whether a beam failure has occurred for the corresponding beam, e.g., 506, of the first TRP 502a. Similarly, the UE measures one or more reference signals from the second TRP 502b to may determinations about whether a beam failure has occurred for the corresponding beam, e.g., 508, of the second TRP 502b. The UE may perform new beam identification individually for the TRPs. In response to a BFD for the beam 508 of the second TRP 502b, the UE transmits a BFR to the base station, at 512. As an example, the UE 504 may transmit a MAC-CE to the base station indicating the beam failure, e.g., a beam failure recovery (BFR) request, for the corresponding TRP. In FIG. 5, the UE 504 may send the BFR request in a MAC-CE to the base station indicating a failed beam for the second TRP 502b. The UE may indicate a new beam, which may be referred to as qnew, to be used with the TRP having the failed beam. The new beam, e.g., the candidate beam reference index qnew, may be from a beam that is based on a candidate reference signal from a configured set of candidate reference signals. For example, the UE may be RRC configured with a list of candidate beam reference signals to be used in connection with BFR. In response to the BFR request, at 512, the UE may receive a BFR response, at 514, from the base station. For example, the BFR response, at 514, may include downlink control information (DCI) that schedules a PUSCH having a particular HARQ identifier (ID) (which may be the same as the previous PUSCH carrying the beam failure recovery request) and having a toggled new data assignment indicator (NDI). At 516, the UE may transmit an uplink transmission, e.g., PUSCH, PUCCH, etc., to the base station (e.g., via the second TRP 502b) using the new beam (e.g., the beam indicated as qnew) in response to the BFR response.

In some aspects, the UE may perform the BFR per TRP. For example, in FIG. 5, the UE transmits the BFR request for the second TRP 502b, whereas the UE may not take an action for the first TRP 502a for which a beam failure is not detected. In other examples, if a beam failure is detected for both the first and second TRPs, the UE may send a BFR request for the first TRP 502a and may send a BFR request for the second TRP 502b. The two BFR requests may be included in combined signaling or separate signaling, yet indicate the beam failures separate for each of the TRPs.

The MAC entity, e.g., the UE 504, may be configured by RRC signaling, or otherwise indicated, per serving cell with a beam failure recovery procedure that the UE 504 may use for indicating to the serving base station a new SSB or a new CSI-RS (e.g., a candidate RS that corresponds to a new beam) when the UE detects a beam failure on the serving SSB(s)/CSI-RS(s) (e.g., on a current serving beam).

In some aspects, the UE may receive the explicit RRC configuration of the set of BFD reference signals. In other aspects, the UE may determine the BFD reference signals based on implicit information, such as based on a TCI of one or more control resource sets (CORESETs) configured for the UE. An RRC configured set of BFD reference signals may have longer periods of time between updates to the configured set, which may introduce latency into beam failure recovery as conditions change between the UE and one or more of the TRPs. In some aspects, the base station may use more frequency signaling, such as a MAC-CE to update a set of BFD reference signals used by the UE. As an example, the base station may transmit a MAC-CE to the UE to update a candidate set of reference signals to be used in connection with BFD and/or BFR, and the indication may be per TRP. As an example, the base station may indicate via MAC-CE an updated set of candidate reference signals for BFD and/or BFR with the first TRP 502a and may separately indicate via MAC-CE an updated set of candidate reference signals for BFD and/or BFR with the second TRP 502b.

Aspects presented herein enable the UE and the network to know when to use an RRC configured set of candidate reference signals for BFD or BFR or whether to use a MAC-CE activated set of candidate reference signals for the BFD or the BFR. The aspects enable the UE and the base station to make the determination for multiple TRPs.

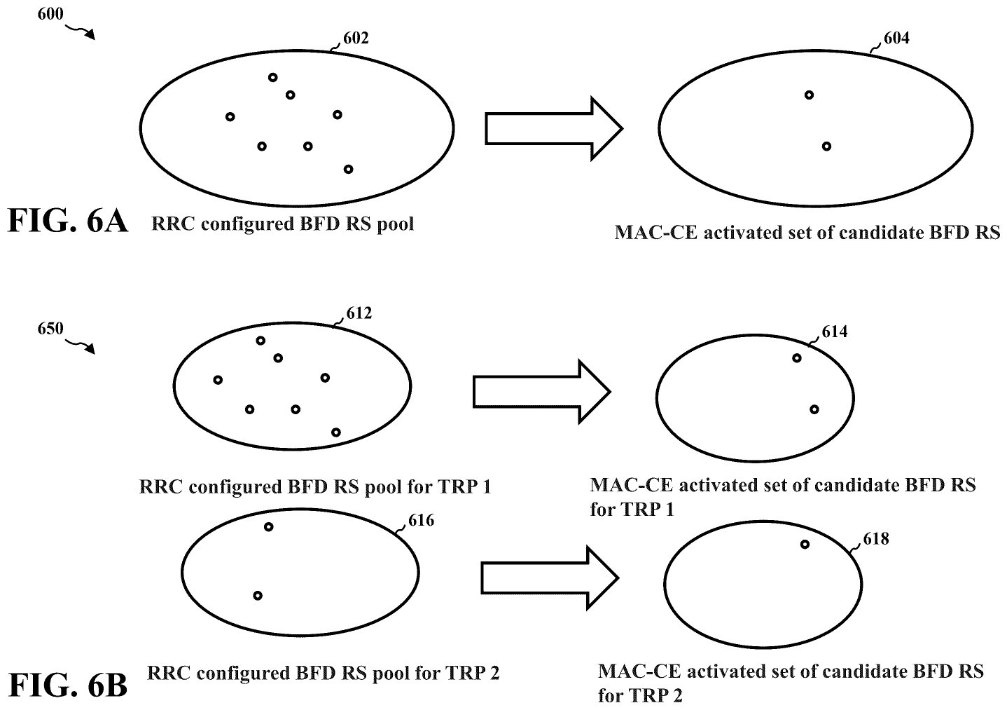

FIG. 6A is a diagram 600 illustrating that a UE may receive an RRC configuration of a first set 602 of one or more reference signals for BFD, e.g., and/or BFR associated with a TRP. The UE may also receive a MAC-CE that indicates a second set 604 of one or more reference signals for the BFD or BFR associated with the TRP. In some aspects, the second set 604 may be a subset of the first set. The first set may be referred to as an RRC configured BFD RS pool, an RRC configured set of candidate BFD RSs, an RRC configured set of candidate RSs, an RRC configured BFD RS set, etc. The second set 604 may be referred to as a MAC-CE activated set of candidate BFD RSs. In some aspects, the UE may receive an activation for a set of candidate BFR RS, e.g., 604, selected from an RRC configured BFD RS pool, e.g., 602, for per TRP BFR operation for the TRP, as described in connection with FIG. 5. In some aspects, the UE may be indicated with an RRC configured BFD RS pool for each of the TRPs, where the RRC configured BFD RS pool for different TRPs may be different. In some other aspects, the UE may be indicated with an RRC configured BFD RS pool for each of the TRPs, where the RRC configured BFD RS pool is common for different TRPs.

Aspects presented herein include various mechanisms that may enable a UE and a base station to determine whether to use an RRC configured set of BFD RS or a MAC-CE activated set of BFD RSs for beam failure detection and/or beam failure recovery for communication with multiple TRPs. In some aspects, the base station may inform UE whether the RRC configured BFD RS set or the MAC-CE based BFD RS set is enabled for BFD and/or BFR.

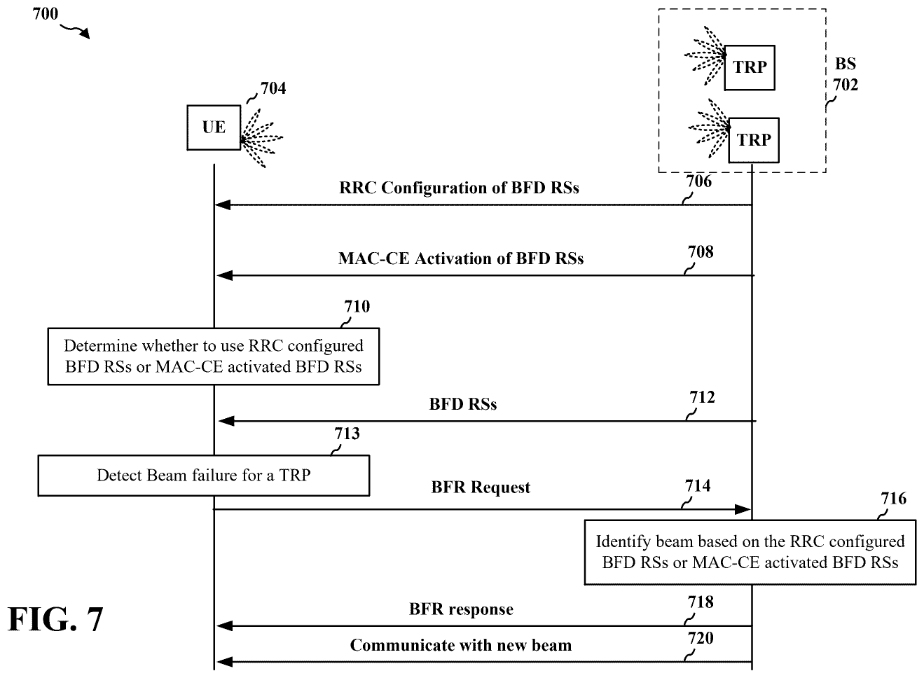

FIG. 7 illustrates an example communication flow 700 between a UE 704 and a base station 702. As illustrated in FIG. 7, the UE may communicate with the base station 702, or otherwise monitor, via multiple TRPs. The base station 702 may transmit an RRC configuration 706 to the UE 704 indicating a set of reference signals for the UE to use in connection with BFD. As an example, the base station 702 may configure a list of reference signals for candidate beams for the UE 704 to use in BFD. If the UE 704 detects a failure of a current beam, as shown at 713, the UE may transmit a BFR request, e.g., at 714, indicating a new beam from the RRC configured set. As illustrated at 708, the base station 702 may also transmit a MAC-CE activating one or more of the reference signals from the RRC configuration 706. At 710, the UE 704 may determine whether to use the RRC configured reference signals or the MAC-CE activated set of reference signals for BFD, e.g., to indicate a new beam in the BFR request 714 when a beam failure is detected for one or more of the TRPs, at 713.

In some aspects, the base station 702 may transmit an indication to the UE 704 that indicates whether the UE is to use the RRC configured set of BFD RSs or the MAC-CE activated set of BFD RSs in a per-TRP BFR operation for a TRP. In some aspects, the indication may be included in the MAC-CE, at 708. In other aspects, the indication may be provided in RRC signaling. In other aspects, the indication may be provided in another transmission from the base station, such as in DCI. The indication may indicate whether the RRC configured BFD RS set is enabled or the MAC-CE activated BFD RS set is enabled for a TRP.

In some aspects, the UE may make the determination, at 710, based on a number of configured BFD RSs, e.g., per TRP. For example, if the number of RRC configured BFD RSs, e.g., configured at 706, is less than or equal to a threshold number of BFD RSs, the UE may determine to use the candidate set of BFD reference signals from the RRC configuration 706 rather than the MAC-CE 708. The threshold number may be based on a maximum number of BFD RSs per TRP. In some aspects, the maximum number may be based on a UE capability to measure BFD RSs per TRP. In such an example, if the RRC configured set of BFD RSs is equal to or less than the UE capability for a maximum number of measured BFD RSs per TRP, the UE may determine, at 710, to use the RRC configured set of BFD RSs and not the MAC-CE activated set.

If the number of RRC configured BFD RSs, e.g., configured at 706, is greater than the threshold number of BFD RSs, the UE may determine to use the activated candidate set of reference signals from the MAC-CE 708 rather than the RRC configuration 706. For example, if the RRC configured set of BFD RSs greater than the UE capability for a maximum number of measured BFD RSs per TRP, the UE may determine, at 710, to use the MAC-CE activated set of BFD RSs and not the RRC configured set. In some aspects, the UE may determine that the RRC configured set of BFD RS is enabled based on the number of candidate BFD RSs that are configured, e.g., the number being less than or equal to the threshold. If the number of RRC configured BFD RSs is greater than the threshold, the UE may determine that the MAC-CE activated BFD RS set is enabled.

As an example, the maximum number of configured BFD RS per TRP may depend on a UE capability. In some aspects, the UE may indicate the UE capability, or support for the capability of the maximum number of configured BFD RS per TRP to the base station. In some aspects, the UE may also indicate the UE capability, or support for the capability of the maximum number of measured BFD RS per TRP to the base station.

As an example, if the UE supports MAC-CE based BFD RS activation, the maximum number of RRC configured BFD RSs per TRP may be 64. In some aspects, the number may be different based on a UE capability,

In some examples, the maximum number of RRC configured BFD RSs per TRP may be fixed, such as 64 or another fixed number. In some example, the maximum number of RRC configured BFD RSs per TRP may be based on a UE capability on a maximum number of configured BFD RS per TRP, which may be 4, 8, 16, 32, or 64 per TRP, or some other number. If the UE can support the MAC-CE activated set of candidate BFD RSs, the maximum number of BFD RSs activated by the MAC-CE may be based on a UE capability of a maximum number of measured BFD RSs per TRP. As an example, the maximum number of BFD RSs that the UE may measure per TRP may be 1 or 2, which would lead to a maximum number of activated BFD RSs in the MAC-CE less than or equal to 1 or 2 per TRP, if the UE supports MAC-CE activated BFD RS.

In some aspects, if the UE does not support MAC-CE activated BFD RS, the maximum number of RRC configured BFD RSs may be based on the UEs capability to measure a maximum of BFD RSs per TRP. As an example, for a maximum number of BFD RSs that a UE can measure per TRP is 2, the maximum number of RRC configured BFD RSs is 2.

If an example of a maximum number of BFD RSs that a UE can measure per TRP is 2, and if the RRC configured set of BFD RSs is 2, the UE may determine to use the RRC configured set of RSs for BFD, e.g., without regard to a MAC-CE activated set. If the RRC configured set of RSs for BFD is more than 2, the UE may use a subset, e.g., of 2 BFD RSs, that are activated in a MAC-CE.

In some example, the UE may be indicated with a first RRC configured BFD RS pool for RRC configured set of BFD RS for each of TRPs, and a second RRC configured BFD RS pool for MAC-CE activated set of RS for each of TRPs. The UE may support a first maximum number of RRC configured BFD RS for the first pool, and may support a second maximum number of RRC configured BFD RS for the second pool. For the first RRC configured BFD RS pool for a TRP, each RS in the pool is used in the RRC configured set of BFD RS for the TRP, and the maximum number of RRC configured BFD RS for the first pool may be equal or less than the maximum number of BFD RSs that a UE can measure per TRP (e.g., 2). For the second RRC configured BFD RS pool for a TRP, the MAC-CE activated set of candidate BFD RS down selects a number of configured BFD RS from the second pool for the TRP, and the maximum number of RRC configured BFD RS for the second pool may be equal or less than the maximum number of configured BFD RSs that a UE can support per TRP (e.g., 64).

Similar to the determination made by the UE at 710, the base station may determine whether the UE is using the RRC configured set of BFD RSs or the MAC-CE activated set of BFD RSs, at 716. The determination may be made in the same manner as described for the determination at 710, e.g., based on an indication to the UE or a number of the RRC configured BFD RSs. The base station may use the determination, at 716, to identify a new beam indicated by the UE in a BFR request 714, for example. The base station 702 may transmit a BFR response 718 to the BFR, as described in connection with FIG. 5, and the UE 704 and the base station 702 may communicate using the new beam, at 720.

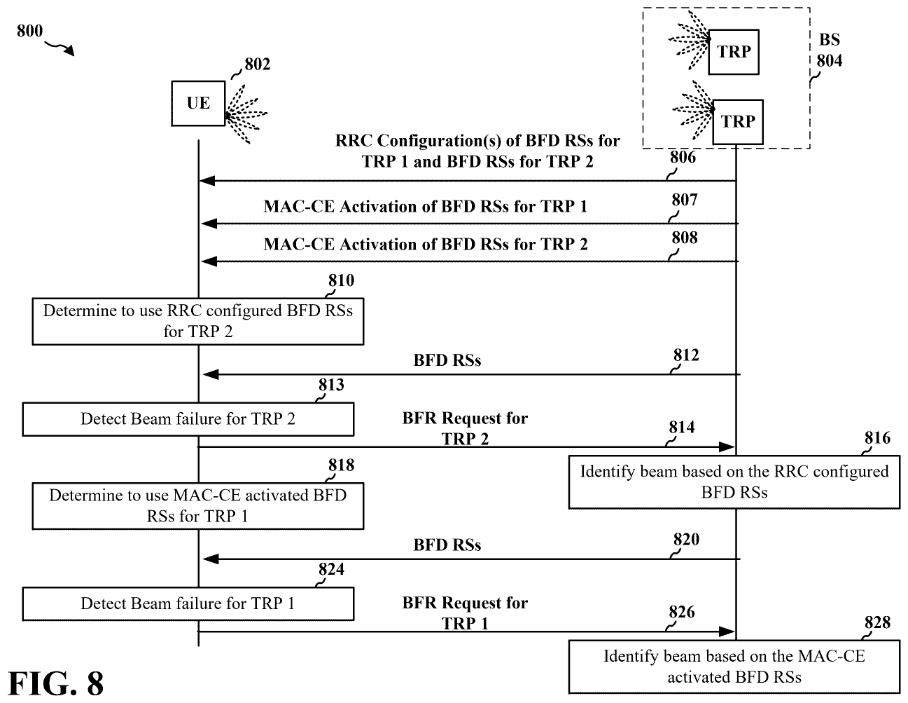

In some aspects, RRC configured set of BFD RS and the MAC-CE activated set of candidate BFD RS may have different RRC configured BFD RS pools per TRP. FIG. 6B illustrates a resource diagram 650 showing a first RRC configured BFD RS pool 612 for TRP 1 and a second RRC configured BF RS pool 616 for TRP 2. A MAC-CE may activate a subset, e.g., 614, of the RRC configured BFD RS pool 612 for TRP 1. A MAC-CE, whether the same MAC-CE or a different MAC-CE, may activated a subset 618 of the RRC configured BFD RS pool for TRP 2. In FIG. 6B, the BFD RS may be separately RRC configured and/or MAC-CE activated in contrast to the example in FIG. 6A. FIG. 8 illustrates an example communication flow 800 between a UE 804 and a base station 802. As illustrated in FIG. 8, the UE 804 may communicate with the base station 802, or otherwise monitor, via multiple TRPs. The base station 802 may transmit an RRC configuration 806 to the UE 804 indicating a set of reference signals for the UE to use in connection with BFD for a first TRP and a second set of reference signals for the UE to use in connection with BFD for a second TRP. The RRC configuration 806 for the two TRPs may be in a single RRC message or may be provided in separate RRC transmissions. As an example, the base station 802 may configure a list of reference signals for candidate BFD beams for the UE 804 to use in BFD with a first TRP and a list of reference signals for candidate BFD beams for the UE 804 to use in BFD with a second TRP. If the UE 804 detects a failure of a current beam for a particular TRP, as shown at 813 and 824, the UE may transmit a BFR request, e.g., at 814 or 826, indicating a new beam from the corresponding RRC configured set. As illustrated at 807, the base station 802 may also transmit a MAC-CE activating one or more of the reference signals from the RRC configuration 806 for the first TRP. As illustrated at 808, the base station 802 may also transmit a MAC-CE activating one or more of the reference signals from the RRC configuration 806 for the second TRP. At 810, the UE 804 may determine whether to use the RRC configured reference signals or the MAC-CE activated set of reference signals for BFD for the first TRP, e.g., to indicate a new beam in the BFR request 814 when a beam failure is detected for the first TRP, at 813. The determination, at 810 and at 818 may be similar to the determination described in connection with 710 in FIG. 7, e.g., and may be based on an indication from the base station and/or a number of the RRC configured BFD RSs in comparison to a maximum number of BFD RSs that a UE can measure per TRP. FIG. 8 illustrates that the UE 804 may make the determination separately for the two TRPs. For example, the UE may determine at 810 to use the RRC configured set of BFD RSs for the TRP 2, and, at 816, the base station 802 may similarly identify a beam indicated in the BFR request 814 based on the RRC configured set of BFD RSs for the TRP 2. FIG. 6B illustrates that the RRC configured set for the TRP 2 may include 2 RSs, which may be equal to or less than a maximum number of BFD RSs, e.g., which may correspond to a maximum number of BFD RSs that a UE supports measuring per TRP. In contrast, the UE may determine to use the MAC-CE activated BFD RSs for the TRP 1, at 818, and may indicate a new beam using a BFD RS from the MAC-CE activated set when sending the BFR request, at 826. The base station 802 may similarly identify a beam indicated in the BFR request 826 based on the MAC-CE activated set of BFD RSs for the TRP 2, at 828. FIG. 6B illustrates an example in which the RRC configured set, e.g., 612, for the TRP 1 may have a number of BFD RSs that is greater than a threshold, e.g., greater than a number of BFD RSs that a UE supports measuring per TRP. In this example, the UE may watch for a MAC-CE to downselect, e.g., activate a subset, of the BFD RSs that are RRC configured for the TRP 1.

As illustrated at 712, 812, and 820, the UE may measure the BFD RSs according to the RRC configured set or the MAC-CE activated set according to the corresponding determination at 710, 810, and 818.

In some aspects, both an RRC configured set and a MAC-CE activated set may be applied by the UE. As an example, the UE may measure the RRC configured set of BFD RSs at a first time, or a first set of times, and may measure the MAC-CE activated set of BFD RSs at a second time, or a second set of times. In some aspects, the UE may determine to use a same kind of BFD RS set for different TRPs. For example, the UE may determine to use RRC configured set of BFD RSs for different TRPs, or the UE may determine to use MAC-CE activated set of BFD RSs for different TRPs. In some aspects, the UE may determine to use different kinds of BFD RS set for different TRPs. For example, the UE may determine to use RRC configured set of BFD RSs for some TRPs, and the UE may determine to use MAC-CE activated set of BFD RSs for some other TRPs.

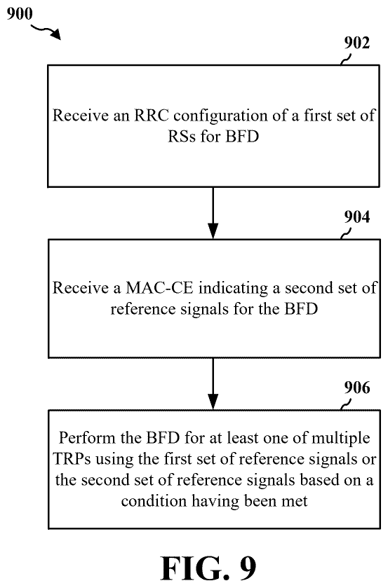

FIG. 9 is a flowchart 900 of a method of wireless communication. The method may be performed by a UE (e.g., the UE 104, 350, 704, 804; the apparatus 1004). The method may enable a UE to determine whether to apply an RRC configured set of BFD RSs or a MAC-CE activated set of BFD RSs, which may be based on a capability supported by the UE.

At 902, the UE receives an RRC configuration of a first set of reference signals for BFD. FIG. 7 and FIG. 8 illustrate various aspects of an RRC configuration 706 and 806. FIG. 6A and FIG. 6B also illustrate example aspects of RRC configured BFD RS sets. The reception may be performed, e.g., by the BFD component 198, the transceiver 1022, and/or the antenna 1080 of the apparatus 1004.

At 904, the UE receives a MAC-CE indicating a second set of reference signals for the BFD. The indication may be for a particular TRP, in some aspects. The reception may be performed, e.g., by the BFD component 198, the transceiver 1022, and/or the antenna 1080 of the apparatus 1004. FIG. 7 and FIG. 8 illustrate various aspects of a MAC-CE 708, 807, and 808. FIG. 6A and FIG. 6B also illustrate example aspects of MAC-CE activated BFD RS sets.

At 906, the UE performs the BFD for at least one of multiple TRPs using the first set of reference signals or the second set of reference signals based on a condition having been met. The BFD may be performed, e.g., by the BFD component 198, the transceiver 1022, and/or the antenna 1080 of the apparatus 1004. The performance of the BFD may include measuring the BFD RSs, and/or indicating a new beam in a BFR request based on one of the BFD RSs, e.g., as described in connection with any of FIGS. 4-8.

In some aspects, the first set of reference signals and the second set of reference signals for the BFD may be indicated from a common pool of BFD reference signals. In some aspects, the UE may receive a MAC-CE activation for a first TRP from the common pool of BFD RSs and may receive a MAC-CE activation for a second TRP from the common pool of BFD RSs. The pool of BFD RSs may be per TRP, and the two sets of BFR RSs may be different.

In some aspects, the UE may further receive a first indication to use the first set of reference signals from the RRC configuration or a second indication to use the second set of reference signals indicated in the MAC-CE, wherein the condition is based on reception of the first indication or the second indication.

In some aspects, the condition may be based on a number of configured reference signals in the RRC configuration for the BFD for each of the multiple TRPs. As an example, the UE may perform the BFD for the multiple TRPs, at 906, using the first set of reference signals indicated in the RRC configuration in response to the number of the configured reference signals in the first set of reference signals being equal to or less than a threshold number of BFD reference signals for a TRP. The threshold number may be based on a capability of the UE for a maximum number of measured the BFD reference signals for the TRP. The UE may perform the BFD for the multiple TRPs using the second set of reference signals indicated in the MAC-CE in response to the number of the configured reference signals in the first set of reference signals being greater than a threshold number of BFD reference signals for a TRP. The threshold number may be based on a capability of the UE for a maximum number of measured the BFD reference signals for the TRP, and the second set of reference signals for the BFD activated by the MAC-CE is less than or equal to the threshold number.

In some aspects, the UE may be provided, for each BWP of a serving cell, with a set q0 of periodic CSI-RS resource configuration indexes by an RRC parameter such as a “failureDetectionResourcesToAddModList” parameter and a set q1 of periodic CSI-RS resource configuration indexes and/or SS/PBCH block indexes by a an RRC parameter, such as a “candidateBeamRSList” parameter, a “candidateBeamRSListExt” parameter, or a “candidateBeamRSSCellList” parameter for radio link quality measurements on the BWP of the serving cell. Instead of the sets q0 and q1, for each BWP of a serving cell, the UE can be provided with respective two sets q0,0 and q0,1 of periodic CSI-RS resource configuration indexes by a first RRC parameter, such as a failureDetectionSet1-r17 parameter and a second RRC parameter, such as a failureDetectionSet2-r17 parameter, that can be activated by a MAC CE and corresponding two sets q1,0 and q1,1 of periodic CSI-RS resource configuration indexes and/or SS/PBCH block indexes by a first RRC parameter candidateBeamRSList1 and a second RRC parameter candidateBeamRSList2, respectively, for radio link quality measurements on the BWP of the serving cell. For each set q0,0 or q0,1, if the number of provided resources is equal to or less than a value of a parameter, such as a NBFD parameter, the UE may consider that the resources in the set are to be measured. The set q0,0 is associated with the set q1,0 and the set q0,1 is associated with the set q1,1. The two sets q0,0 and q0,1 may be updated by a MAC-CE.

In some aspects, the RRC configuration may indicate the first set of reference signals is RRC configured for the BFD with a first TRP of the multiple TRPs and a third set of reference signals for the BFD with a second TRP of the multiple TRPs, wherein to perform the BFD for the at least one of the multiple TRPs, the UE may perform the BFD for the first TRP using the first set of reference signals or the second set of reference signals based on the condition; and perform the BFD for the second TRP using the third set of reference signals in the RRC configuration or a fourth set of reference signals indicated in MAC-CE signaling based on the condition. The BFD for the first TRP may be performed based on the first set of reference signals in the RRC configuration based on the condition being met for the first TRP, and the BFD is performed for the second TRP based on the fourth set of reference signals indicated via the MAC-CE signaling based on the condition not being met for the second TRP.

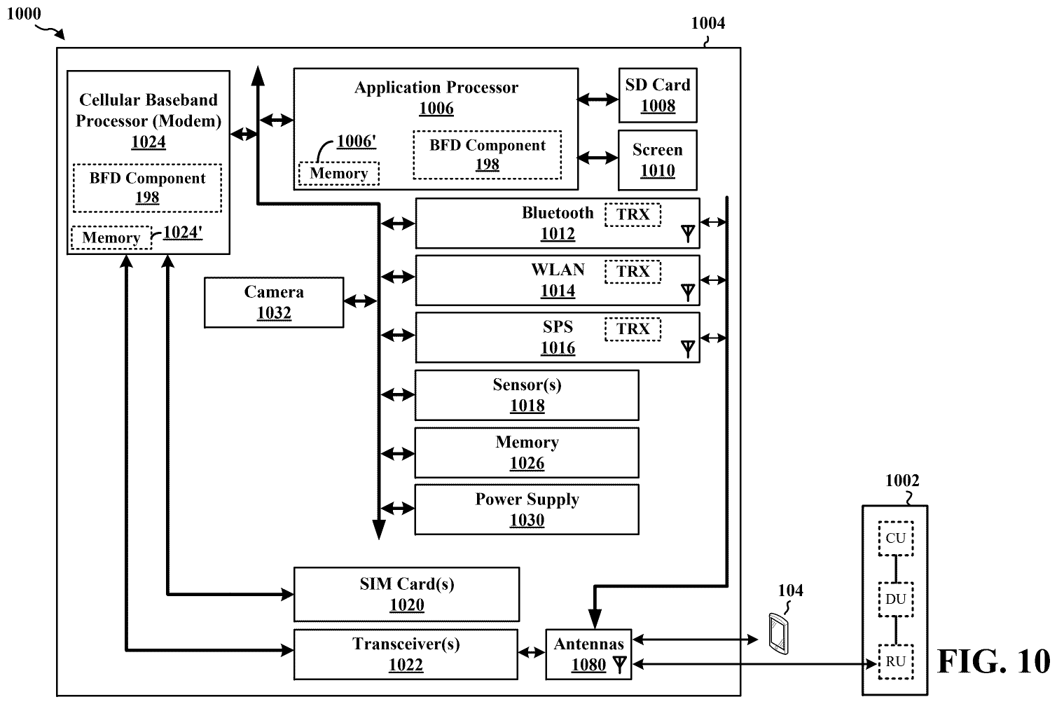

FIG. 10 is a diagram 1000 illustrating an example of a hardware implementation for an apparatus 1004. The apparatus 1004 may be a UE, a component of a UE, or may implement UE functionality. In some aspects, the apparatus1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra.

The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the component 198 is configured to receive an RRC configuration of a first set of reference signals for BFD, receive a MAC-CE indicating a second set of reference signals for the BFD, and perform the BFD for at least one of multiple TRPs using the first set of reference signals or the second set of reference signals based on a condition having been met. In some aspects, the BFD component 198 may be further configured to receive receiving a first indication to use the first set of reference signals from the RRC configuration or a second indication to use the second set of reference signals indicated in the MAC-CE, wherein the condition is based on reception of the first indication or the second indication. The component 198 may be within the cellular baseband processor 1024, the application processor 1006, or both the cellular baseband processor 1024 and the application processor 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, may include means for receiving a RRC configuration of a first set of reference signals for BFD, means for receiving a MAC-CE indicating a second set of reference signals for the BFD, and means for performing the BFD for at least one of multiple TRPs using the first set of reference signals or the second set of reference signals based on a condition having been met. In some aspects, the apparatus 1004 may further include means for receiving a first indication to use the first set of reference signals from the RRC configuration or a second indication to use the second set of reference signals indicated in the MAC-CE, wherein the condition is based on reception of the first indication or the second indication. The apparatus 1004 may include means for performing any of the aspects described in connection with the flowchart in FIG. 9 and/or the aspects performed by the UE in FIG. 7 or FIG. 8. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

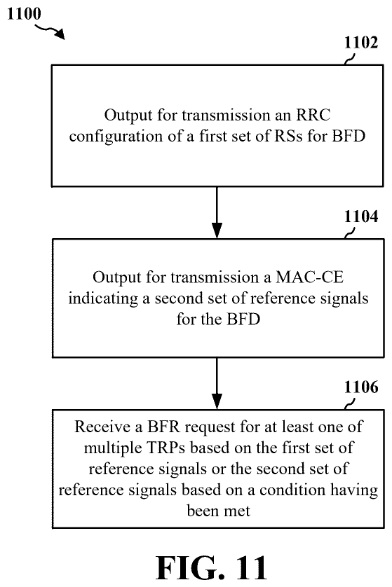

FIG. 11 is a flowchart 1100 of a method of wireless communication. The method may be performed by a network node such as a base station or a component of a base station (e.g., the base station 102, 310, 702, 802; the CU 110; the DU 130; the RU 140; the network entity 1202). The method may enable a network node to determine whether to apply an RRC configured set of BFD RSs or a MAC-CE activated set of BFD RSs, which may be based on a capability supported by the UE.

At 1102, the network node outputs for an RRC configuration of a first set of reference signals for BFD. FIG. 7 and FIG. 8 illustrate various aspects of an RRC configuration 706 and 806. FIG. 6A and FIG. 6B also illustrate example aspects of RRC configured BFD RS sets. The reception may be performed, e.g., by the BFD component 198, the transceiver 1022, and/or the antenna 1080 of the apparatus 1004. The output may be performed, e.g., by the BFD RS configuration component 199.

At 1104, the network node outputs for transmission a MAC-CE indicating a second set of reference signals for the BFD. The indication may be for a particular TRP, in some aspects. FIG. 7 and FIG. 8 illustrate various aspects of a MAC-CE 708, 807, and 808. FIG. 6A and FIG. 6B also illustrate example aspects of MAC-CE activated BFD RS sets.

The output may be performed, e.g., by the BFD RS configuration component 199.

At 1106, the network node receives a BFR request for at least one of multiple TRPs based on the first set of reference signals or the second set of reference signals based on a condition having been met. The reception may be performed, e.g., by the BFD RS configuration component 199. The BFR may include any of the aspects described in connection with any of FIGS. 4-8.

In some aspects, the first set of reference signals and the second set of reference signals for the BFD are indicated from a common pool of BFD reference signals

The network node may further output for transmission a first indication to use the first set of reference signals from the RRC configuration or a second indication to use the second set of reference signals indicated in the MAC-CE, wherein the condition is based on reception of the first indication or the second indication.

In some aspects, the condition may be based on a number of configured reference signals in the RRC configuration for the BFD for each of the multiple TRPs.

The BFR request for a TRP of the multiple TRPs may be based on the first set of reference signals indicated in the RRC configuration in response to the number of the configured reference signals in the first set of reference signals being equal to or less than a threshold number of BFD reference signals for the TRP. The threshold number may be based on a capability of a UE for a maximum number of measured the BFD reference signals for the TRP. The BFR request for a TRP of the multiple TRPs may be based on the second set of reference signals indicated in the MAC-CE in response to the number of the configured reference signals in the first set of reference signals being greater than a threshold number of BFD reference signals for the TRP. The threshold number may be based on a capability of a UE for a maximum number of measured the BFD reference signals for the TRP, and the second set of reference signals for the BFD activated by the MAC-CE is less than or equal to the threshold number.

The RRC configuration may indicate the first set of reference signals is RRC configured for the BFD with a first TRP of the multiple TRPs, including indicating a third set of reference signals for the BFD with a second TRP of the multiple TRPs; and indicating a fourth set of reference signals indicated in MAC-CE signaling based on the condition, wherein the condition is determined separately for the first TRP and the second TRP.

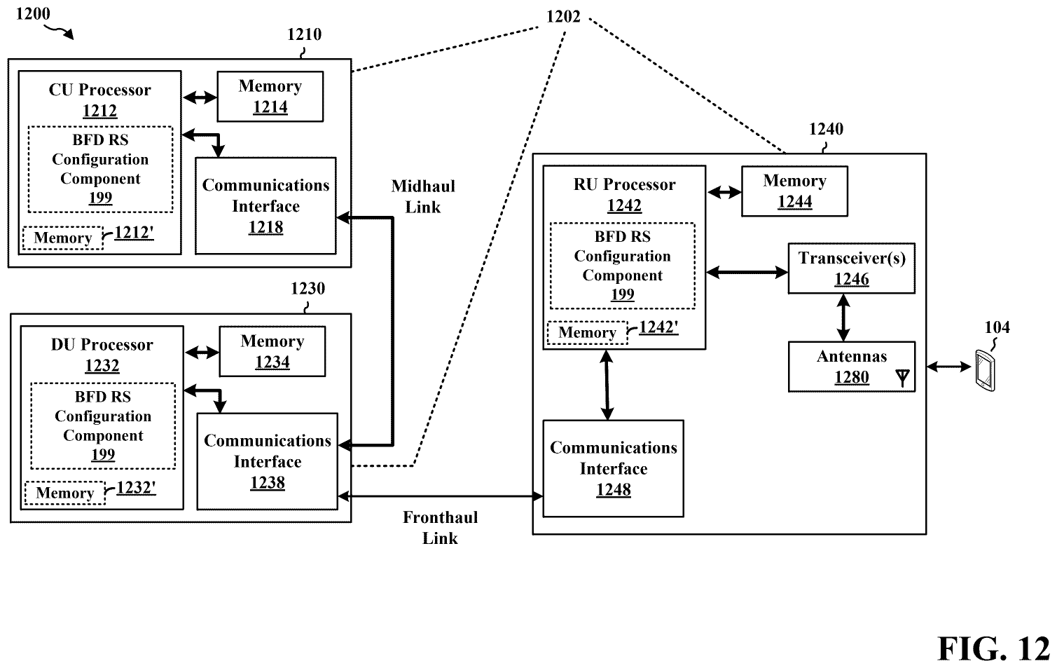

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240.

The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to output for transmission an RRC configuration of a first set of reference signals for BFD; output for transmission a MAC-CE indicating a second set of reference signals for the BFD; and receive a BFR request for at least one of multiple TRPs based on the first set of reference signals or the second set of reference signals based on a condition having been met. The BFD RS configuration component 199 may be further configured to output for transmission a first indication to use the first set of reference signals from the RRC configuration or a second indication to use the second set of reference signals indicated in the MAC-CE, wherein the condition is based on reception of the first indication or the second indication. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for outputting for transmission an RRC configuration of a first set of reference signals for BFD; means for outputting for transmission a MAC-CE indicating a second set of reference signals for the BFD; and means for receiving a BFR request for at least one of multiple TRPs) based on the first set of reference signals or the second set of reference signals based on a condition having been met. The network entity 1202 may further include means for outputting for transmission a first indication to use the first set of reference signals from the RRC configuration or a second indication to use the second set of reference signals indicated in the MAC-CE, wherein the condition is based on reception of the first indication or the second indication. The network entity 1202 may include means for performing any of the aspects described in connection with the flowchart in FIG. 11 and/or the aspects performed by the base station in FIG. 7 or FIG. 8. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving an RRC configuration of a first set of reference signals for BFD; receiving a MAC-CE indicating a second set of reference signals for the BFD; and performing the BFD for at least one of multiple TRPs using the first set of reference signals or the second set of reference signals based on a condition having been met.

In aspect 2, the method of aspect 1 further includes that the first set of reference signals and the second set of reference signals for the BFD is indicated from a common pool of BFD reference signals.

In aspect 3, the method of aspect 1 or aspect 2 further includes receiving a first indication to use the first set of reference signals from the RRC configuration or a second indication to use the second set of reference signals indicated in the MAC-CE, wherein the condition is based on reception of the first indication or the second indication.

In aspect 4, the method of aspect 1 or aspect 2 further includes that the condition is based on a number of configured reference signals in the RRC configuration for the BFD for each of the multiple TRPs.

In aspect 5, the method of aspect 4 further includes that the UE performs the BFD for the multiple TRPs using the first set of reference signals indicated in the RRC configuration in response to the number of the configured reference signals in the first set of reference signals being equal to or less than a threshold number of BFD reference signals for a TRP.

In aspect 6, the method of aspect 5 further includes that the threshold number is based on a capability of the UE for a maximum number of measured the BFD reference signals for the TRP.

In aspect 7, the method of aspect 4 further includes that the UE performs the BFD for the multiple TRPs using the second set of reference signals indicated in the MAC-CE in response to the number of the configured reference signals in the first set of reference signals being greater than a threshold number of BFD reference signals for a TRP.

In aspect 8, the method of aspect 7 further includes that the threshold number is based on a capability of the UE for a maximum number of measured the BFD reference signals for the TRP, and the second set of reference signals for the BFD activated by the MAC-CE is less than or equal to the threshold number.

In aspect 9, the method of aspect 1 or aspects 3 to 8 further includes that the RRC configuration indicates the first set of reference signals is RRC configured for the BFD with a first TRP of the multiple TRPs and a third set of reference signals for the BFD with a second TRP of the multiple TRPs, wherein performing the BFD for the at least one of the multiple TRPs includes: performing the BFD for the first TRP using the first set of reference signals or the second set of reference signals based on the condition; and performing the BFD for the second TRP using the third set of reference signals in the RRC configuration or a fourth set of reference signals indicated in MAC-CE signaling based on the condition.

In aspect 10, the method of aspect 9 further includes that the BFD for the first TRP is performed based on the first set of reference signals in the RRC configuration based on the condition being met for the first TRP, and the BFD is performed for the second TRP based on the fourth set of reference signals indicated via the MAC-CE signaling based on the condition not being met for the second TRP.

Aspect 11 is an apparatus for wireless communication including means for performing the method of any of aspects 1-10.

Aspect 12 is an apparatus for wireless communication including a memory; and at least one processor coupled to the memory and, based at least in part on information stored in the memory, the at least one processor is configured to perform the method of any of aspects 1-10.

In aspect 13, the apparatus of aspect 11 or aspect 12 further includes at least one transceiver or at least one antenna coupled to the at least one processor.

Aspect 14 is a non-transitory computer-readable medium storing computer executable code, the code when executed by at least one processor causes the at least one processor to implement a method as in any of aspects 1-10.

Aspect 15 is a method of wireless communication at a network node, comprising: outputting for transmission an RRC configuration of a first set of reference signals for BFD; outputting for transmission a MAC-CE indicating a second set of reference signals for the BFD; and receiving a BFR request for at least one of multiple TRPs based on the first set of reference signals or the second set of reference signals based on a condition having been met.

In aspect 16, the method of aspect 15 further includes that the first set of reference signals and the second set of reference signals for the BFD is indicated from a common pool of BFD reference signals.

In aspect 17, the method of aspect 15 or aspect 16 further includes outputting for transmission a first indication to use the first set of reference signals from the RRC configuration or a second indication to use the second set of reference signals indicated in the MAC-CE, wherein the condition is based on reception of the first indication or the second indication.

In aspect 18, the method of aspect 15 or aspect 16 further includes that the condition is based on a number of configured reference signals in the RRC configuration for the BFD for each of the multiple TRPs.

In aspect 19, the method of aspect 18 further includes that the BFR request for a TRP of the multiple TRPs is based on the first set of reference signals indicated in the RRC configuration in response to the number of the configured reference signals in the first set of reference signals being equal to or less than a threshold number of BFD reference signals for the TRP.

In aspect 20, the method of aspect 19 further includes that the threshold number is based on a capability of a UE for a maximum number of measured the BFD reference signals for the TRP.

In aspect 21, the method of aspect 18 further includes that the BFR request for a TRP of the multiple TRPs is based on the second set of reference signals indicated in the MAC-CE in response to the number of the configured reference signals in the first set of reference signals being greater than a threshold number of BFD reference signals for the TRP.

In aspect 22, the method of aspect 21 further includes that the threshold number is based on a capability of a UE for a maximum number of measured the BFD reference signals for the TRP, and the second set of reference signals for the BFD activated by the MAC-CE is less than or equal to the threshold number.

In aspect 23, the method of aspect 15 or 17-22 further includes that the RRC configuration indicates the first set of reference signals is RRC configured for the BFD with a first TRP of the multiple TRPs, the method further comprising: indicating a third set of reference signals for the BFD with a second TRP of the multiple TRPs; and indicating a fourth set of reference signals indicated in MAC-CE signaling based on the condition, wherein the condition is determined separately for the first TRP and the second TRP.

Aspect 24 is an apparatus for wireless communication including means for performing the method of any of aspects 15-23.

Aspect 25 is an apparatus for wireless communication including a memory; and at least one processor coupled to the memory and, based at least in part on information stored in the memory, the at least one processor is configured to perform the method of any of aspects 15-23.

In aspect 26, the apparatus of aspect 24 or aspect 25 further includes at least one transceiver or at least one antenna coupled to the at least one processor.

Aspect 27 is a non-transitory computer-readable medium storing computer executable code, the code when executed by at least one processor causes the at least one processor to implement a method as in any of aspects 15-23.

What is claimed is:

1. An apparatus for wireless communication at a user equipment (UE), comprising:
a memory; and
at least one processor coupled to the memory and, based at least in part on information stored in the memory, the at least one processor is configured to:
receive a radio resource control (RRC) configuration of a first set of reference signals for beam failure detection (BFD);
receive a medium access control-control element (MAC-CE) indicating a second set of reference signals for the BFD; and
perform the BFD for at least one of multiple transmission reception points (TRPs) using the first set of reference signals or the second set of reference signals based on a condition having been met.

2. The apparatus of claim 1, wherein the first set of reference signals and the second set of reference signals for the BFD are indicated from a common pool of BFD reference signals.

3. The apparatus of claim 1, wherein the at least one processor is further configured to:
receive a first indication to use the first set of reference signals from the RRC configuration or a second indication to use the second set of reference signals indicated in the MAC-CE, wherein the condition is based on reception of the first indication or the second indication.

4. The apparatus of claim 1, wherein the condition is based on a number of configured reference signals in the RRC configuration for the BFD for each of the multiple TRPs.

5. The apparatus of claim 4, wherein the at least one processor is further configured to perform the BFD for the multiple TRPs using the first set of reference signals indicated in the RRC configuration in response to the number of the configured reference signals in the first set of reference signals being equal to or less than a threshold number of BFD reference signals for a TRP.

6. The apparatus of claim 5, wherein the threshold number is based on a capability of the UE for a maximum number of measured the BFD reference signals for the TRP.

7. The apparatus of claim 4, wherein the at least one processor is further configured to perform the BFD for the multiple TRPs using the second set of reference signals indicated in the MAC-CE in response to the number of the configured reference signals in the first set of reference signals being greater than a threshold number of BFD reference signals for a TRP.

8. The apparatus of claim 7, wherein the threshold number is based on a capability of the UE for a maximum number of measured the BFD reference signals for the TRP, and the second set of reference signals for the BFD activated by the MAC-CE is less than or equal to the threshold number.

9. The apparatus of claim 1, wherein the RRC configuration indicates the first set of reference signals is RRC configured for the BFD with a first TRP of the multiple TRPs and a third set of reference signals for the BFD with a second TRP of the multiple TRPs, wherein to perform the BFD for the at least one of the multiple TRPs, the at least one processor is configured to:
perform the BFD for the first TRP using the first set of reference signals or the second set of reference signals based on the condition; and
perform the BFD for the second TRP using the third set of reference signals in the RRC configuration or a fourth set of reference signals indicated in MAC-CE signaling based on the condition.

10. The apparatus of claim 9, wherein the BFD for the first TRP is performed based on the first set of reference signals in the RRC configuration based on the condition being met for the first TRP, and the BFD is performed for the second TRP based on the fourth set of reference signals indicated via the MAC-CE signaling based on the condition not being met for the second TRP.

11. The apparatus of claim 1, further include at least one transceiver coupled to the at least one processor and configured to receive the RRC configuration and the MAC-CE.

12. A method of wireless communication at a user equipment (UE), comprising:
receiving a radio resource control (RRC) configuration of a first set of reference signals for beam failure detection (BFD);
receiving a medium access control-control element (MAC-CE) indicating a second set of reference signals for the BFD; and
performing the BFD for at least one of multiple transmission reception points (TRPs) using the first set of reference signals or the second set of reference signals based on a condition having been met.

13. The method of claim 12, wherein the first set of reference signals and the second set of reference signals for the BFD are indicated from a common pool of BFD reference signals.

14. The method of claim 12, further comprising:
receiving a first indication to use the first set of reference signals from the RRC configuration or a second indication to use the second set of reference signals indicated in the MAC-CE, wherein the condition is based on reception of the first indication or the second indication.

15. The method of claim 12, wherein the condition is based on a number of configured reference signals in the RRC configuration for the BFD for each of the multiple TRPs.

16. The method of claim 15, wherein the UE performs the BFD for the multiple TRPs using the first set of reference signals indicated in the RRC configuration in response to the number of the configured reference signals in the first set of reference signals being equal to or less than a threshold number of BFD reference signals for a TRP.

17. The method of claim 16, wherein the threshold number is based on a capability of the UE for a maximum number of measured the BFD reference signals for the TRP.

18. The method of claim 15, wherein the UE performs the BFD for the multiple TRPs using the second set of reference signals indicated in the MAC-CE in response to the number of the configured reference signals in the first set of reference signals being greater than a threshold number of BFD reference signals for a TRP.

19. The method of claim 18, wherein the threshold number is based on a capability of the UE for a maximum number of measured the BFD reference signals for the TRP, and the second set of reference signals for the BFD activated by the MAC-CE is less than or equal to the threshold number.

20. The method of claim 12, wherein the RRC configuration indicates the first set of reference signals is RRC configured for the BFD with a first TRP of the multiple TRPs and a third set of reference signals for the BFD with a second TRP of the multiple TRPs, wherein performing the BFD for the at least one of the multiple TRPs includes:
performing the BFD for the first TRP using the first set of reference signals or the second set of reference signals based on the condition; and
performing the BFD for the second TRP using the third set of reference signals in the RRC configuration or a fourth set of reference signals indicated in MAC-CE signaling based on the condition.

21. The method of claim 20, wherein the BFD for the first TRP is performed based on the first set of reference signals in the RRC configuration based on the condition being met for the first TRP, and the BFD is performed for the second TRP based on the fourth set of reference signals indicated via the MAC-CE signaling based on the condition not being met for the second TRP.

22. An apparatus for wireless communication at a network node, comprising:
a memory; and
at least one processor coupled to the memory and, based at least in part on information stored in the memory, the at least one processor is configured to:
output for transmission a radio resource control (RRC) configuration of a first set of reference signals for beam failure detection (BFD);
output for transmission a medium access control-control element (MAC-CE) indicating a second set of reference signals for the BFD; and
receive a beam failure recovery (BFR) request for at least one of multiple transmission reception points (TRPs) based on the first set of reference signals or the second set of reference signals based on a condition having been met.

23. The apparatus of claim 22, wherein the first set of reference signals for the BFD and the second set of reference signals for the BFD are indicated from a common pool of BFD RSs, the at least one processor being further configured to:
output for transmission a first indication to use the first set of reference signals from the RRC configuration or a second indication to use the second set of reference signals indicated in the MAC-CE, wherein the condition is based on reception of the first indication or the second indication.

24. The apparatus of claim 22, wherein the condition is based on a number of configured reference signals in the RRC configuration for the BFD for each of the multiple TRPs,
wherein the BFR request for a TRP of the multiple TRPs is based on the first set of reference signals indicated in the RRC configuration in response to the number of the configured reference signals in the first set of reference signals being equal to or less than a threshold number of BFD reference signals for the TRP, or
wherein the BFR request for a TRP of the multiple TRPs is based on the second set of reference signals indicated in the MAC-CE in response to the number of the configured reference signals in the first set of reference signals being greater than the threshold number of BFD reference signals for the TRP.

25. The apparatus of claim 24, wherein the threshold number is based on a capability of a user equipment (UE) for a maximum number of measured the BFD reference signals for the TRP, and the second set of reference signals for the BFD activated by the MAC-CE is less than or equal to the threshold number.

26. The apparatus of claim 22, wherein the RRC configuration indicates the first set of reference signals is RRC configured for the BFD with a first TRP of the multiple TRPs, the at least one processor being further configured to:
indicate a third set of reference signals for the BFD with a second TRP of the multiple TRPs; and
indicate a fourth set of reference signals indicated in MAC-CE signaling based on the condition, wherein the condition is determined separately for the first TRP and the second TRP.

27. The apparatus of claim 22, further including at least one transceiver coupled to the at least one processor.

28. A method of wireless communication at a network node, comprising:
outputting for transmission a radio resource control (RRC) configuration of a first set of reference signals for beam failure detection (BFD);
outputting for transmission a medium access control-control element (MAC-CE) indicating a second set of reference signals for the BFD; and
receiving a beam failure recovery (BFR) request for at least one of multiple transmission reception points (TRPs) based on the first set of reference signals or the second set of reference signals based on a condition having been met.

29. The method of claim 28, further including:
outputting for transmission a first indication to use the first set of reference signals from the RRC configuration or a second indication to use the second set of reference signals indicated in the MAC-CE, wherein the condition is based on reception of the first indication or the second indication.

30. The method of claim 28, wherein the condition is based on a number of configured reference signals in the RRC configuration for the BFD for each of the multiple TRPs,
wherein the BFR request for a TRP of the multiple TRPs is based on the first set of reference signals indicated in the RRC configuration in response to the number of the configured reference signals in the first set of reference signals being equal to or less than a threshold number of BFD reference signals for the TRP, or
wherein the BFR request for a TRP of the multiple TRPs is based on the second set of reference signals indicated in the MAC-CE in response to the number of the configured reference signals in the first set of reference signals being greater than the threshold number of BFD reference signals for the TRP.
